(19) United States
(12) Patent Application Publication
(10) Pub. No.: US 2015/0168862 A1
(43) Pub. Date: Jun. 18, 2015

(54) ELECTROSTATIC CHARGE IMAGE DEVELOPING CARRIER AND TWO-COMPONENT DEVELOPER

(71) Applicant: Konica Minolta, Inc., Tokyo (JP)

(72) Inventors: Kosuke Nakamura, Tokyo (JP); Satoshi Uchino, Tokyo (JP); Koji Shibata, Tokyo (JP)

(21) Appl. No.: 14/547,689

(22) Filed: Nov. 19, 2014

(30) Foreign Application Priority Data
Dec. 13, 2013 (JP) 2013-257571

(51) Int. Cl. G03G 9/113

(52) U.S. Cl. CPC G03G 9/1133

(57) ABSTRACT

Provided is an electrostatic charge image developing carrier and a two-component developer capable of stably obtaining a high-definition image by preventing fogging and toner scattering associated with a change in the electrostatic property of a toner associated with a change in temperature and humidity of the environment, particularly, a decrease in electrification quantity in a high-temperature high-humidity environment.

An electrostatic charge image developing carrier includes a carrier particle formed by coating a surface of a core material particle with a coating material including a resin, the resin is obtained by polymerizing a monomer including at least an alicyclic methacrylic acid ester compound, the coating material contains a sulfur element, and a ratio (S/C) of a sulfur element content (S) to a carbon element content (C) in the coating material is 0.003 to 0.008.

### CROSS-REFERENCE TO RELATED APPLICATION

This application is based on Japanese Patent Application No. 2013-257571 filed on Dec. 13, 2013, the contents of which are incorporated herein by reference.

### BACKGROUND

1. Technical Field

The present invention relates to an electrostatic charge image developing carrier (hereinafter, also simply referred to as a “carrier”) and a two-component developer used in an electrophotographic image forming method.

2. Description of Related Art

Recently, for high quality image, a chemical toner having spherical-shaped small particles manufactured by suspension polymerization, emulsion aggregation, or the like has been used. Since this chemical toner is hydrolytically manufactured, the toner has a nature of being apt to adsorb water and having a high dependence of an electrification quantity on the environment as compared with a pulverized toner.

In order to reduce an environmental difference in the electrostatic property of a toner, hydrophobization of a resin material of a carrier has been promoted. In the related art, it is known that a silicone resin is used as a resin material.

However, the silicone resin is hard and does not wear down. Thus, there is such a problem that a toner is spent on surfaces of carrier particles (adhesion of grains or external additives of toner particles, or components of toner particles to surfaces of carrier particles is referred to as spent), resulting in degradation of an electrification property.

For example, Japanese Patent Application Laid-Open No. 7-77841 proposes a two-component developer including a toner manufactured by suspension polymerization and a carrier having a defined amount of sulfur on the surface, in order to suppress charge-up of a carrier in a low-temperature low-humidity environment. However, this two-component developer has such a problem that hydrophobicity of the carrier is not sufficient and an electrification quantity decreases in a high-temperature high-humidity environment, resulting in fogging or toner scattering.

For example, Japanese Patent Application Laid-Open No. 4-208944 proposes a carrier using poly(p-t-butyl styrene) or a resin including a sulfur-containing terminal group, which is a polymer of p-t-butyl styrene and an alkyl methacrylate having 1 to 4 carbon atoms, in order to control electrostatic property. However, even if this carrier is used, there is such a problem that an electrification quantity decreases in a high-temperature high-humidity environment.

### SUMMARY

The present invention was achieved in view of the circumstances described above. Therefore, an object of the present invention is to provide an electrostatic charge image developing carrier and a two-component developer capable of stably obtaining a high-definition image by preventing a change in the electrostatic property of a toner associated with a change in temperature and humidity of the environment, particularly, preventing fogging and toner scattering associated with a decrease in electrification quantity in a high-temperature high-humidity environment.

To achieve at least one of the above-mentioned objects, an electrostatic charge image developing carrier reflecting on aspect of the present invention comprising a carrier particle formed by coating a surface of a core material particle with a coating material including a resin,

wherein the resin being obtained by polymerizing a monomer including at least an alicyclic methacrylic acid or an alicyclic acrylic acid ester compound, and

the coating material comprising a sulfur element, and a ratio (S/C) of the sulfur element content (S) to a carbon element content (C) in the coating material being 0.003 to 0.008.

In the above-mentioned electrostatic charge image developing carrier of the present invention, preferably, the alicyclic methacrylic acid ester compound has a cycloalkyl group having 5 to 8 carbon atoms.

### DETAILED DESCRIPTION

Hereinafter, the present invention will be described in detail.

<<Two-Component Developer>>

A two-component developer of the present invention comprises a toner formed of a toner particle containing a sulfur element and a carrier formed of a carrier particle, and the carrier particle is formed by coating a surface of a core material particle with a coating material containing a sulfur element. A two-component developer of the present invention, preferably, comprising: an electrostatic charge image developing toner formed of a toner particle; and an electrostatic charge image developing carrier formed of a carrier particle, wherein the electrostatic charge image developing carrier is the blow-described electrostatic charge image developing carrier, and the toner particle constituting the electrostatic charge image developing toner contains a sulfur element.

According to the two-component developer of the present invention, the two-component developer contains the above-described electrostatic charge image developing carrier and an electrostatic charge image developing toner formed of a toner particle containing a sulfur element. Thus, it is achieved to stably obtain a high-definition image by preventing a change in the electrostatic property of a toner associated with a change in temperature and humidity of the environment, particularly, preventing fogging and toner scattering associated with a decrease in electrification quantity in a high-temperature high-humidity environment.

Hereinafter, ingredients of the two-component developer of the present invention will be described in sequence.

<Carrier>

The carrier of the present invention is formed of a carrier particle formed by coating a surface of a core material particle with a coating material including a resin (hereinafter, also referred to as a “coating resin”). This coating material contains a sulfur element.

According to the electrostatic charge image developing carrier of the present invention, a carrier particle is formed by coating a surface of a core material particle with a coating material including a resin obtained by polymerizing a monomer including an alicyclic methacrylic acid ester compound, and a ratio (S/C) of a sulfur element content (S) to a carbon element content (C) in the coating material is in a specific range. Thus, it is possible to stably obtain a high-definition image by preventing fogging and toner scattering associated with a change in the electrostatic property of a toner associated with a change in temperature and humidity of the environment, particularly, a decrease in the electrification quantity in a high-temperature high-humidity environment.

(Core Material Particle)

The core material particle forming the carrier particle is formed of various kinds of ferrite in addition to metallic powder such as iron powder. Of these, ferrite is preferred.

As the ferrite, ferrite containing heavy metal such as copper, zinc, nickel, and manganese, or light metal ferrite including alkali metal or alkaline-earth metal is preferred.

Ferrite is a compound represented by (MO)ₓ(Fe₂O₃)_{y}, and preferably, the molar ratio y of Fe₂O₃ forming the ferrite is 30 to 95 mol %. Since ferrite having a composition ratio yin the above range is apt to obtain desired magnetization, and thus, the ferrite has the advantage that a carrier which causes less carrier adhesion can be fabricated. In the formula, M denotes an atom of metal such as manganese (Mn), magnesium (Mg), strontium (Sr), calcium (Ca), titanium (Ti), copper (Cu), zinc (Zn), nickel (Ni), aluminum (Al), silicon (Si), zirconium (Zr), bismuth (Bi), cobalt (Co), and lithium (Li), which can be used alone or in combination of two or more thereof.

(Coating Material)

The coating material forming the carrier particle is formed of a coating resin and further contains a sulfur element. The sulfur element may be included in the coating material as a constituent element of the coating resin or may be contained in the coating material as a constituent element of a separate additive from the coating resin.

Generally, it is known that in a coating material of a resin coating type carrier particle, presence of a trace element greatly affects an electrostatic property. In the present invention, the coating material forming the carrier particle contains a sulfur element, and the sulfur element functions as a starting point of electrification when the carrier particle and the toner particle rub against each other.

(Coating Resin)

The coating resin is obtained by polymerizing a monomer including at least an alicyclic methacrylic acid ester compound or an alicyclic acrylic acid ester compound.

In the present invention, the alicyclic methacrylic acid ester compound having a high hydrophobicity is used as a monomer for obtaining the coating resin, and thus, a water adsorption amount of the carrier particle decreases, an environmental difference in the electrostatic property decreases, and in particular, a decrease in electrification quantity in a high-temperature high-humidity environment is suppressed. Furthermore, a resin obtained by polymerizing the monomer including an alicyclic methacrylic acid or an alicyclic acrylic acid ester compound has suitable mechanical strength and undergoes appropriate film abrasion as a coating material. Thus, a surface of the carrier particle is refreshed.

The monomer for obtaining the coating resin may include, for example, a chain methacrylic acid or a chain acrylic acid ester compound, a styrene compound, and the like in addition to the alicyclic methacrylic acid ester compound.

The alicyclic methacrylic acid or an alicyclic acrylic acid ester compound is a compound in which an alcohol-derived site of a methacrylic acid or an acrylic acid ester compound is formed of a cycloalkyl group. Preferably, the alicyclic methacrylic acid or the alicyclic acrylic acid ester compound has a cycloalkyl group having 5 to 8 carbon atoms, and specifically examples thereof include methacrylic acid cyclopentyl, acrylic acid cyclopentyl, methacrylic acid cyclohexyl, acrylic acid cyclohexyl, methacrylic acid cycloheptyl, acrylic acid cycloheptyl, and methacrylic acid cyclooctyl, acrylic acid cyclooctyl. Of these, methacrylic acid cyclohexyl, acrylic acid cyclohexyl is particularly preferred from the viewpoint of a mechanical strength and environmental stability of an electrification quantity. In the above-mentioned electrostatic charge image developing carrier of the present invention, preferably, the alicyclic methacrylic acid ester compound is methacrylic acid cyclohexyl.

The chain methacrylic acid or the chain acrylic acid ester compound is a compound in which an alcohol-derived site of a methacrylic acid or an acrylic acid ester compound is formed of a chain alkyl group. Specifically, examples of the chain methacrylic acid ester or the chain acrylic acid compound include methacrylic acid methyl, methacrylic acid ethyl, methacrylic acid propyl, methacrylic acid n-butyl, methacrylic acid hexyl, methacrylic acid octyl, methacrylic acid 2-ethylhexyl, acrylic acid methyl, acrylic acid ethyl, acrylic acid propyl, acrylic acid n-butyl, acrylic acid hexyl, acrylic acid octyl, and acrylic acid 2-ethylhexyl. Preferably, the chain methacrylic acid or the chain acrylic acid ester compound is methyl methacrylate.

Examples of the styrene compound include styrene or styrene derivatives such as styrene, α-methyl styrene, and para-chloro styrene.

Preferably, the monomer for obtaining the coating resin includes an alicyclic methacrylic acid or an alicyclic acrylic acid ester compound and a chain methacrylic acid or a chain acrylic acid ester compound, from the viewpoint of coexistence of wear resistance and electric resistance. In the above-mentioned electrostatic charge image developing carrier of the present invention, preferably, the monomer for obtaining the resin includes an alicyclic methacrylic acid ester compound and a chain methacrylic acid ester compound. In particular, preferably, the monomer for obtaining the coating resin includes an alicyclic methacrylic acid or an alicyclic acrylic acid ester compound and methacrylic acid methyl or acrylic acid methyl.

A rate of the alicyclic methacrylic acid or the alicyclic acrylic acid ester compound in the monomer for obtaining the coating resin is preferably 20 to 80% by mass and more preferably 30 to 70% by mass. In the above-mentioned electrostatic charge image developing carrier of the present invention, preferably, a rate of the alicyclic methacrylic acid ester compound in the monomer for obtaining the resin is 20 to 80% by mass.

Since the rate of the alicyclic methacrylic acid ester compound is in the above-described range, hydrophobicity of the coating resin can be secured, and thus, a change in the electrostatic property due to a change in temperature and humidity of the environment can be small.

A weight average molecular weight of the coating resin is preferably within a range of 300,000 to 1,000,000.

By the weight average molecular weight of the coating resin to be within the above range, strength of the resin can be increased to some extent. Then, since the costing resin undergoes appropriate film abrasion, it is possible to obtain an effect of refreshing a surface of the carrier particle.

The weight average molecular weight of the coating resin is measured using GPC (gel permeation chromatography).

In other words, a measuring sample is dissolved in tetrahydrofuran so as to have a concentration of 1 mg/ml. As the dissolution conditions, the dissolution is carried out at room temperature for 5 minutes using an ultrasonic homogenizer. Then, the solution is treated using a 0.2 μm pore size membrane filter, and subsequently 10 μL of the sample solution is poured into the GPC.

—GPC Measurement Condition—

Device: HLC-8220 (manufactured by TOSOH Corporation)

Column: TSKguardcolumn+TSKgelSuperHZM-M3 Ren (manufactured by TOSOH Corporation)

Column Temperature: 40° C.

Solvent: Tetrahydrofuran

Flow Rate: 0.2 ml/min

Detector: Refractive index detector (RI detector)

In the molecular weight measurement of the sample, the molecular weight distribution of the sample is calculated using a calibration curve, which is measured by using a monodispersed standard polystyrene particle. 10 points are used for polystyrene for the calibration curve measurement.

(Sulfur Element)

The sulfur element contained in the coating material may form a part of the coating resin or may be present as a separate compound including a sulfur element from the coating resin. For example, during polymerization of the coating resin, the sulfur element may be contained in the coating material by using a polymerization initiator having a sulfur element or by using a compound having a sulfur element as a monomer for obtaining the coating resin, or may be contained in the coating material by adding a compound having a sulfur element thereto.

In the present invention, preferably, the coating material contains the sulfur element as a sulfonic acid group or a sulfonate group because starting of electrification is accelerated by appropriately promoting electron transfer. In the electrostatic charge image developing carrier of the present invention, preferably, the coating material contains the sulfur element as a sulfonic acid group or a sulfonate group. In particular, preferably, the coating resin contains the sulfur element as a sulfonic acid group or a sulfonate group at a molecular chain end of the resin. In the above-mentioned electrostatic charge image developing carrier of the present invention, preferably, the resin contains the sulfur element as a sulfonic acid group or a sulfonate group. This is because the molecular chain end is prone to be oriented outside the resin and thus more sulfur elements can be present on the surface. In the present invention, the sulfur element can be introduced as a sulfonic acid group or a sulfonate group into the molecular chain end of the coating resin by using a polymerization initiator having a sulfur element.

In this manner, by introducing the sulfur element into the molecular chain end of the coating resin, the molecular chain end has a high mobility and the molecular chain end is apt to be exposed on the surface of the resin. Thus, a small amount of the sulfur element can exhibit the effect. Since the amount of the sulfur element as a polar group decreases inside the resin, hydrophobicity of the resin is held and water adsorption is suppressed.

When the coating resin is obtained by being polymerized by suspension polymerization or emulsion polymerization, the sulfur element having a high polarity is oriented outside the resin particle, which is thus preferred.

(Method of Introducing Sulfur Element into Coating Material)

As a method of allowing the sulfur element to be contained in the coating material, a sulfur element can be introduced into the coating resin by polymerizing the monomer including an alicyclic methacrylic acid or an alicyclic acrylic acid ester compound by suspension polymerization or emulsion polymerization using a polymerization initiator having a sulfur element. In this case, it is possible to introduce the sulfur element into the molecular chain end of the coating resin.

Examples of the polymerization initiator having a sulfur element include persulfates such as ammonium persulfate, sodium persulfate, and potassium persulfate. Of these, potassium persulfate (KHSO₅) is preferred.

In the present invention, since the sulfur element is introduced as a sulfonic acid group or a sulfonate group into the molecular chain end of the coating resin by using the polymerization initiator having a sulfur element as a polymerization initiator, starting of electrification is accelerated by appropriately promoting electron transfer, which is thus preferred.

Preferably, an amount of the polymerization initiator having the sulfur element to be used is 0.1 to 2% by mass with respect to the total amount of the monomer.

As other introducing methods, the sulfur element can be introduced into the coating material by polymerizing a monomer including the alicyclic methacrylic acid or the alicyclic acrylic acid ester compound by suspension polymerization or emulsion polymerization using a surfactant having a sulfur element in the molecule to obtain the coating resin, and allowing the surfactant to remain.

Examples of the method of allowing the surfactant to remain in the coating material include a method of adjusting an amount of the surfactant to be used and a method of adjusting the number of times of washing the coating resin obtained by polymerization or the washing time. An example of the method of washing the coating resin includes a method of polymerizing a resin and subsequently repeating filtering and re-dispersion of the resin in ion exchanged water or a mixed solvent of ion exchanged water and alcohol.

As the surfactant having a sulfur element, an anionic surfactant is preferred. As the anionic surfactant, a surfactant having a sulfonic acid group or a sulfonate group as a hydrophilic group is preferred. Examples of such a surfactant include mono-alkyl sulfate (ROSO₃⁻M⁺), alkyl polyoxyethylene sulfate (RO(CH₂CH₂O)ₘSO₃⁻M⁺), or alkylbenzene sulfonate (RR′CH₂CHC₆H₄SO₃⁻M⁺). Specifically, examples of these surfactants include sodium benzene sulfonate, ammonium lauryl sulfonate, sodium lauryl sulfonate, sodium polyoxyethylene lauryl ether sulfonate, polyoxyethylene lauryl ether sulfonate triethanolamine, higher sodium alcohol sulfonate, and lauryl sulfonate triethanolamine. Of these, sodium benzene sulfonate is preferred.

By using the above-described method, the sulfur element can be contained as a sulfonic acid group or a sulfonate group in the coating material.

Preferably, an amount of the surfactant having the sulfur element to be used is 0.1 to 1.5% by mass with respect to the total amount of the monomer.

As other introduction methods, the sulfur element can be introduced into the coating resin by polymerizing the alicyclic methacrylic acid or the alicyclic acrylic acid ester compound monomer and the monomer including a compound including a sulfur element by suspension polymerization or emulsion polymerization.

Examples of the compound having a sulfur element as a monomer include sulfonated styrene such as sulfonic acid p-styrene, and sulfonated methacrylate such as sulfoethyl methacrylate, and sulfobutyl methacrylate. Comparing to introducing a sulfur element into a molecular end by use of the polymerization initiator, use of the monomer less affects on imparting electrification characteristic. Meanwhile, it is not desirable because water absorption of the whole resin increases under high humidity and electrification characteristic deteriorates.

The ratio (S/C) of a sulfur element content (S) to a carbon element content (C) in the coating material is within a range of 0.003 to 0.008 and more preferably 0.0035 to 0.007, as measured by an X-ray photoelectronic spectrum analyzer. Preferably, the ratio (S/C) of the sulfur element content (S) to the carbon element content (C) in the coating material is 0.0035 to 0.007.

Since the ratio (S/C) in the coating material is within the above range, starting of electrification brought by conferring of an electrostatic property and appropriate electron transfer is improved.

As described above, the ratio (S/C) in the coating material can be controlled by adjusting an amount of the polymerization initiator having a sulfur element to be used, an amount of the surfactant having a sulfur element to be used, a degree of washing the surfactant having a sulfur element, and an amount of a compound having a sulfur element as a monomer to be used.

The ratio (S/C) in the coating material is measured using an X-ray photoelectronic spectrum analyzer.

Specifically, with an X-ray photoelectronic spectrum analyzer, “K-Alpha” (manufactured by Thermo Fisher Scientific K.K.), quantitative analysis of a sulfur element and a carbon element is conducted under the following analysis conditions. A surface element concentration is calculated from a peak area of each atom using a relative sensitivity factor, and the value of the ratio (S/C) of a surface element concentration (S) of the sulfur element to a surface element concentration (C) of the carbon element is calculated.

(Preliminary Preparation)

A sample (two-component developer), a small amount of a neutral detergent, and pure water are added into a beaker and mixed thoroughly, and a supernatant is discarded while applying a magnet to the bottom of the beaker. Pure water is further added thereto and the supernatant is discarded to remove a toner and the neutral detergent, thereby separating a carrier only. The resultant product is dried at 40° C. to obtain a carrier simplex.

(Fabrication of Sample)

A carrier is put into a pore (diameter 3 mm, depth 1 mm) of a powder measuring plate and a surface thereof is a level with the pore to make a measuring sample.

(Measurement Condition)

X-ray: Al monochrome light source

Acceleration: 12 kV, 6 mA

Beam diameter: 400 μm

Pass Energy: 50 eV

Step Size: 0.1 eV

(Method of Manufacturing Carrier)

A carrier particle forming the carrier of the present invention is formed by coating a surface of a core material particle with a coating material. As the method of coating a surface of a core material particle with a coating material, a dry coating method is preferred. As the dry coating method, for example, a hybridizer (manufactured by Nara Machinery Co., Ltd.) having a rotor and a liner may be used, but preferably, a high-speed stirring mixer equipped with a horizontal stirring blade is used.

(Average Film Thickness of Coating Material)

An average film thickness of the coating material on the carrier particle is preferably within a range of 0.05 to 4.0 μm and more preferably within a range of 0.2 to 3.0 μm from the viewpoint of coexistence of durability and low electric resistance of the carrier.

When the average film thickness of the coating material is within the above range, an electrostatic property and durability can be provided within a preferable range.

The average film thickness of the coating material is a value calculated by the following method.

A carrier slice is made using a focused ion beam device, “SMI2050” (manufactured by Hitachi High-Tech Science Corporation), and subsequently, a cross section of the slice is observed by a transmission electron microscope “JEM-2010F” (manufactured by JEOL Ltd.) in a field of vision at a magnification of 5000 times. The average value of a portion having the maximum film thickness and a portion having the minimum film thickness in the field of vision is used as an average film thickness of the coating material.

In the carrier of the present invention, a particle diameter thereof is preferably within a range of 15 to 80 μm and more preferably within a range of 20 to 70 μm in terms of median diameter (D₅₀) based on volume.

When the particle diameter of the carrier is within the above range, a high-definition toner image can be stably formed.

The median diameter based on volume of the carrier can be measured by a laser diffraction type particle size distribution meter equipped with a wet-type dispersion device, “HELOS & RODOS” (manufactured by Sympatec).

In the carrier of the present invention, an electrical resistivity thereof is preferably within a range of 10⁷ to 10¹² Ω·cm and more preferably within a range of 10⁸ to 10¹¹ Ω·cm.

When the electrical resistivity of the carrier is within the above range, the carrier is optimized for formation of a high-concentration toner image.

In the carrier of the present invention, preferably, saturation magnetization thereof is within a range of 30 to 80 Am²/kg and residual magnetization is equal to or less than 5.0 Am²/kg.

When the carrier having the above-described magnetic properties is used, the carrier is prevented from partially aggregate, and the two-component developer is uniformly dispersed on a surface of a developer transfer member. Thus, it is possible to form a uniform and high quality image toner image without imbalance in concentration.

The residual magnetization can be lowered by using ferrite. When the residual magnetization is small, fluidity of the carrier is improved and a two-component developer having a uniform bulk density can be obtained.

<Toner>

The toner constituting the two-component developer of the present invention is formed of a toner particle including a sulfur element.

The toner particle is formed of at least a binder resin and further contains a sulfur element. The sulfur element may be contained in the toner particle as a constituent element of the binder resin or may be contained in the toner particle as a constituent element of a separate additive from the binder resin.

Generally, it is known that in a coating material of a carrier and in a toner particle, presence of a trace element greatly affects an electrostatic property. In the present invention, the coating material of the carrier and the toner particle contain a sulfur element, and the sulfur element functions as a starting point of electrification when the carrier particle and the toner particle rub against each other. Since the toner contains the sulfur element as an element greatly affecting an electrostatic property in common with the carrier, it is possible to prepare the toner particle and the carrier particle with the same behavior of change in the electrostatic property each other with respect to water. Therefore, it is considered that in the case of the two-component developer, it is possible to greatly improve a change in the electrostatic property due to a change in temperature and humidity of the environment as compared with the related art.

(Sulfur Element)

The sulfur element contained in the toner particle may form a part of the binder resin or may be present as a separate compound having a sulfur element from the binder resin. Specifically, during polymerization of the binder resin, the sulfur element may be contained in the toner particle by using a polymerization initiator having a sulfur element or by using a compound having a sulfur element as a monomer for obtaining the binder resin, or may be contained in the toner particle by adding a compound having a sulfur element thereto.

In the present invention, preferably, the toner particle contains the sulfur element as a sulfonic acid group or a sulfonate group because starting of electrification is accelerated by appropriately promoting electron transfer. In particular, most preferably, the binder resin contains the sulfur element as a sulfonic acid group or a sulfonate group at a molecular chain end of the binder resin. This is because the molecular chain end is prone to be oriented outside the resin and thus more sulfur elements can be present on the surface. In the present invention, the sulfur element can be introduced as a sulfonic acid group or a sulfonate group into the molecular chain end of the binder resin by using a polymerization initiator having a sulfur element.

As such, it is preferable to introduce the sulfur element as a sulfonic acid group or a sulfonate group into the molecular chain end of the binder resin because more sulfur elements can be present on the surface of the toner particle.

(Method of Introducing Sulfur Element into Toner Particle)

As a method of allowing the sulfur element to be contained in the toner particle, the sulfur element can be introduced into the binder resin by polymerizing the monomer for forming the binder resin by suspension polymerization or emulsion polymerization using a polymerization initiator having a sulfur element. In this case, the sulfur element is introduced into the molecular chain end of the binder resin.

As the polymerization initiator having a sulfur element, the same initiator as the polymerization initiator described above is used. Of these, potassium persulfate is preferred.

As other introducing methods, the sulfur element can also be introduced into the toner particle by manufacturing the toner particle by emulsion aggregation. In other words, the sulfur element can be introduced into the toner particle by mixing, aggregating, and fusing an aqueous-based dispersion of the binder resin polymerized by suspension polymerization or emulsion polymerization with an aqueous-based dispersion of a colorant using a surfactant having a sulfur element to obtain the toner particle, and allowing the surfactant to remain.

Examples of the method of allowing the surfactant to remain in the toner particle include a method of adjusting an amount of the surfactant to be used and a method of adjusting the number of times of washing the toner particle obtained or the washing time. An example of the method of washing the toner particle includes a method of repeating filtering and re-dispersion of the toner particle in ion exchanged water or a mixed solvent of ion exchanged water and alcohol.

As the surfactant having a sulfur element, a same surfactant as the surfactant described above can be used. Of these, sodium dodecyl sulfonate is preferred.

By using the above-described method, the sulfur element can be contained as a sulfonic acid group or a sulfonate group in the toner particle.

As other introducing methods, the sulfur element can be introduced into the binder resin by polymerizing a monomer including a compound having a sulfur element by suspension polymerization or emulsion polymerization.

As the compound having a sulfur element as a monomer, the same compound as the compound described above can be used.

The ratio (S/C) of a sulfur element content (S) and a carbon element content (C) in the toner particle is preferably within a range of 0.001 to 0.006 as measured by an X-ray photoelectronic spectrum analyzer.

When the ratio (S/C) in the toner particle is within the above range, starting of electrification caused by an electrostatic property and appropriate electron transfer is improved.

The ratio (S/C) in the toner particle is measured using an X-ray photoelectronic spectrum analyzer in the same manner as the above-described measurement method except that the toner is used instead of the sample.

As described above, the ratio (S/C) in the toner particle can be controlled by adjusting an used amount of the polymerization initiator having a sulfur element, an used amount of the surfactant having a sulfur element, a degree of washing the surfactant having a sulfur element, and an used amount of a compound having a sulfur element as a monomer.

(Binder Resin)

As the binder resin forming the toner particle, a thermoplastic resin is preferably used.

As the binder resin, those typically used as a binder resin forming a toner particle can be used without any particular limitation, and specifically, examples of the binder resin include a styrene-based resin, an acryl-based resin such as alkyl acrylate and alkyl methacrylate, a styrene acryl-based copolymer resin, a polyester resin, a silicone resin, an olefin-based resin, an amide resin, and an epoxy resin.

Of these, for example, the styrene-based resin, the acryl-based resin, the styrene acryl-based copolymer resin, and the polyester resin, having a low viscosity and a high sharp-melt characteristic as a melt characteristic are preferred. Preferably, the styrene acryl-based copolymer resin is used as a main resin in 50% or more. These resins can be used alone or in combination of two or more thereof.

As a polymerizable monomer for obtaining the binder resin, for example, styrene compounds such as styrene, methyl styrene, methoxy styrene, butyl styrene, phenyl styrene, and chloro styrene; methacrylic acid ester compounds such as methacrylic acid methyl, methacrylic acid ethyl, methacrylic acid butyl, and methacrylic acid ethylhexyl; acrylic acid ester compounds such as acrylic acid methyl, acrylic acid ethyl, acrylic acid butyl, and acrylic acid ethylhexyl; and carboxylate-based compounds such as acrylic acid, methacrylic acid, and fumaric acid.

These compounds can be used alone or in combination of two or more thereof.

Preferably, the binder resin has a glass transition point temperature (Tg) of 30 to 50° C. from the viewpoint of low temperature fixing. When the glass transition point temperature is within the above range, a low temperature fixing property and a heat resistance storage property are improved.

The glass transition point temperature (Tg) of the binder resin can be measured using a “Diamond DSC” (manufactured by ParkinElmer Co., Ltd.).

As the measuring procedure, 3.0 mg of the sample (toner) is sealed in an aluminum pan to be set in a holder. An empty aluminum pan is used as a reference. Temperature control of heating-cooling-heating (Heat-Cool-Heat) is conducted under the measurement conditions including a measurement temperature of 0 to 200° C., a temperature rising rate of 10° C./minute, and a temperature lowering rate of 10° C./minute to conduct analysis based on data during the second heating (2nd. Heat).

As for the glass transition temperature, an intersection point of the extension of the base line before starting of the first endothermic peak with a tangential line indicating the maximum inclination from the starting portion of the first peak to the top of the peak is indicated as a glass transition point.

The binder resin has a softening point temperature of preferably 80 to 130° C., and more preferably 90 to 120° C.

The softening point temperature can be measured using, for example, a flow tester, “CFT-500D” (manufactured by Shimadzu Corporation).

The toner particle may contain other components, such as a colorant, a release agent, and a charge control agent as necessary.

(Colorant)

In the case of the constitution in which the toner particle contains a colorant, an organic colorant as well as carbon black and a magnetic substance can optionally be used as the colorant.

As the organic colorant, for example, C.I. Pigment Red 2, C.I. Pigment Red 3, C.I. Pigment Red 5, C.I. Pigment Red 7, C.I. Pigment Red 15, C.I. Pigment Red 16, C.I. Pigment Red 48:1, C.I. Pigment Red 48:3, C.I. Pigment Red 53:1, C.I. Pigment Red 57:1, C.I. Pigment Red 81:4, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 208, C.I. Pigment Red 209, C.I. Pigment Red 222, C.I. Pigment Orange 31, C.I. Pigment Orange 43, C.I. Pigment Yellow 3, C.I. Pigment Yellow 9, C.I. Pigment Yellow 14, C.I. Pigment Yellow 17, C.I. Pigment Yellow 35, C.I. Pigment Yellow 36, C.I. Pigment Yellow 65, C.I. Pigment Yellow 74, C.I. Pigment Yellow 83, C.I. Pigment Yellow 93, C.I. Pigment Yellow 94, C.I. Pigment Yellow 98, C.I. Pigment Yellow 110, C.I. Pigment Yellow 111, C.I. Pigment Yellow 138, C.I. Pigment Yellow 139, C.I. Pigment Yellow 153, C.I. Pigment Yellow 155, C.I. Pigment Yellow 180, C.I. Pigment Yellow 181, C.I. Pigment Yellow 185, C.I. Pigment Green 7, C.I. Pigment Blue 15:3, C.I. Pigment Blue 15:4, C.I. Pigment Blue 60, and a phthalocyanine pigment containing zinc, titanium, magnesium, and the like as central metals can be used, and mixtures thereof can also be used. As a dye, C. I. Solvent Red 1, C.I. Solvent Red 3, C.I. Solvent Red 14, C.I. Solvent Red 17, C.I. Solvent Red 18, C.I. Solvent Red 22, C.I. Solvent Red 23, C.I. Solvent Red 49, C.I. Solvent Red 51, C.I. Solvent Red 52, C.I. Solvent Red 58, C.I. Solvent Red 63, C.I. Solvent Red 87, C.I. Solvent Red 111, C.I. Solvent Red 122, C.I. Solvent Red 127, C. I. Solvent Red 128, C.I. Solvent Red 131, C.I. Solvent Red 145, C.I. Solvent Red 146, C.I. Solvent Red 149, C.I. Solvent Red 150, C.I. Solvent Red 151, C.I. Solvent Red 152, C. I. Solvent Red 153, C.I. Solvent Red 154, C.I. Solvent Red 155, C.I. Solvent Red 156, C.I. Solvent Red 157, C.I. Solvent Red 158, C.I. Solvent Red 176, C.I. Solvent Red 179, a pyrazolo triazole azo dye, a pyrazolo triazole azo methine dye, a pyrazolone azo dye, a pyrazolone azo methine dye, C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 60, C.I. Solvent Blue 70, C.I. Solvent Blue 93, C.I. Solvent Blue 95, and the like can be used, and mixtures thereof can also be used.

The amount of the colorant to be added is within a range of 1 to 30% by mass and preferably 2 to 20% by mass with respect to the whole toner.

(Release Agent)

In the case of the constitution in which the toner particle contains a release agent, there is no particular limitation in the release agent. Examples of the release agent can include hydrocarbon-based wax such as polyethylene wax, oxidized polyethylene wax, polypropylene wax, and oxidized polypropylene wax, carnauba wax, fatty acid ester wax, sasol wax, rice wax, candelilla wax, jojoba oil wax, and bees wax.

The content rate of the release agent is typically 1 to 30 parts by mass, and preferably 5 to 20 parts by mass with respect to 100 parts by mass of the binder resin.

(Charge Control Agent)

In the case of the constitution in which the toner particle contains a charge control agent, examples of the charge control agent can include a metal complex of zinc or aluminum of salicylate derivatives (salicylate metal complex), a calixarene-based compound, an organic boron compound, and a fluorine-containing quaternary ammonium salt compound.

The content rate of the charge control agent is typically 0.1 to 5.0 parts by mass with respect to 100 parts by mass of the binder resin.

(Method of Manufacturing Toner)

Examples of the method of manufacturing the toner forming the two-component developer of the present invention include a kneading-pulverizing method, suspension polymerization, emulsion aggregation, a dissolution suspension method, a polyester extension method, and a dispersion polymerization method.

Of these, the emulsion aggregation is preferably used from the viewpoint of uniformity of the particle diameter, shape controllability, and the ease of forming a core-shell structure, which are advantageous for high quality image and high stability.

The emulsion aggregation is a method of manufacturing a toner by mixing a dispersion of a fine binder resin particle (hereinafter also referred to as a “fine resin particle”) dispersed using a surfactant or a dispersion stabilizer with a dispersion of a toner particle constituent such as a fine colorant particle as necessary, adding an aggregating agent to the mixture to allow aggregation until a desired toner particle diameter is achieved, and subsequently or at the same time as the aggregation, fusing fine resin particles to control the shape.

Here, the fine resin particle may optionally contains an internal additive such as a release agent and a charge control agent and can also be a composite particle, and may be formed with a plurality of layers including two or more layers formed of resins with different compositions.

It is preferable to add different types of fine resin particles at the time of aggregation to form a toner particle having a core-shell structure from the viewpoint of the design of the structure of the toner.

The fine resin particle can be manufactured by, for example, an emulsion polymerization method, a miniemulsion polymerization method, or a phase-transfer emulsification method or can be manufactured by a combination of several manufacturing methods. When the internal additive is contained in the fine resin particle, among them, the miniemulsion polymerization method is preferably used.

(External Additive)

The dried toner particle can directly be used as the toner particle. However, from the viewpoint of improving the electrification property, fluidity, or a cleaning property as the toner, it is preferable to add a particle such as a known inorganic particle or organic particle or a lubricant to a surface thereof as an external additive.

A method of adding the external additive is carried out by adding and mixing the external additive to the dried toner particle as necessary.

Specifically, an example thereof includes a dry method in which the external additive in the form of powder is added to the dried toner particle. An example of a mixing apparatus includes a mechanical mixing apparatus such as a Henschel mixer and a coffee mill.

Preferably, the toner used in the present invention has a particle diameter within a range of 3 to 8 μM in terms of a median diameter (D₅₀) based on volume.

The median diameter (D₅₀) based on volume of the toner is measured using a measuring device in which a computer system equipped with data processing software “Software V3.51” is connected to “Coulter Multisizer 3” (manufactured by Beckman Coulter, Inc.).

Specifically, 0.02 g of the sample (toner) is added to and mixed thoroughly with 20 ml of a surfactant solution (a surfactant solution obtained, for example, by diluting a neutral detergent including a surfactant component ten-fold with pure water for the purpose of dispersing the toner), and subsequently ultrasonic dispersion is performed for 1 minute to prepare a toner dispersion. This toner dispersion is poured using a pipette into a beaker held in a sample stand and containing “ISOTON II” (manufactured by Beckman Coulter, Inc.) until the concentration displayed on the measuring device reaches 8%. Here, by using the above concentration range, a repeatable measurement value can be obtained. Then, in the measuring device, the number of particles to be counted is set to 25,000, and the diameter of an aperture is set to 50 μm. The range of 1 to 30 μm as the measurement range is divided into 256 sections, and a frequency value in each section is calculated. The median diameter (D₅₀) based on volume is determined as a particle diameter of 50% of the cumulative volume fraction from the largest volume fraction.

The toner used in the present invention has an average circularity preferably in the range of 0.900 to 0.970 and more preferably in the range of 0.930 to 0.965 from the viewpoint of improvement in transfer efficiency.

The average circularity of the toner can be measured using a flow particle image analyzer, “FPIA-2100” (manufacture by Sysmex Corporation). Specifically, the sample (toner) is mixed thoroughly in a surfactant-containing aqueous solution and subjected to ultrasonic dispersion treatment for 1 minute to disperse the toner. Subsequently, images of the toner are taken using a flow particle image analyzer, “FPIA-2100” (manufacture by Sysmex Corporation) in an HPF (high-power field) mode of the measurement condition at an appropriate concentration of the particle number detected in the HPF mode of 3,000 to 10,000. The circularity is calculated for each toner particle using the following Formula (1), the circularities of the respective toner particles are summed up, and the sum is divided by the total number of toner particles to calculate the average circularity. In the following Formula (1), a “diameter of equivalent circle” refers to a diameter of a circle having the same area as a particle image.

circularity=perimeter of circle obtained from diameter of equivalent circle/perimeter of projected particle image Formula (1)

<Method of Fabricating Two-Component Developer>

The two-component developer of the present invention can be fabricated by mixing the carrier and the toner with use of a mixing apparatus.

Examples of the mixing apparatus can include a Henschel mixer (manufactured by Nippon Coke & Engineering Co., Ltd.), a nauta mixer (manufactured by Hosokawa Micron Group), and a V-type mixer.

A compounding ratio of the carrier and the toner is preferably 3 to 15 parts by mass of the toner and more preferably 4 to 10 parts by mass of the toner with respect to 100 parts by mass of the carrier.

In the two-component developer of the present invention, a sulfur element greatly affecting an electrostatic property is included in both the toner and the carrier, it is possible to uniform behaviors of change in the electrification property of the toner and the carrier associated with a change in temperature and humidity of the environment. Therefore, it is possible to stably obtain a high quality image by preventing a change in the electrostatic property of a toner associated with a change in temperature and humidity of the environment, particularly, preventing fogging and toner scattering associated with a decrease in electrification quantity in a high-temperature high-humidity environment.

<<Electrophotographic Image Forming Method>>

The two-component developer of the present invention can be used in various known electrophotographic image forming methods. For example, the two-component developer can be used in a monochrome image forming method or a full color image forming method. In the full color image forming method, any of image forming methods can be used, including a 4 cycle type image forming method using four kinds of color developing apparatuses for respective yellow, magenta, cyan, and black and one electrostatic latent image carrier and a tandem type image forming method in which a color developing apparatus for each color and an image forming unit having an electrostatic latent image carrier are equipped for each color.

Specifically, as the electrophotographic image forming method, for example, the two-component developer of the present invention is used to electrify an electrostatic latent image carrier with an electrification apparatus (electrification process), and an electrostatic latent image electrostatically formed by exposing an image (exposure process) is developed in a developing apparatus by electrifying a toner particle with a carrier particle in the two-component developer of the present invention so as to obtain a toner image (development process). Then, this toner image is transferred to a sheet (transfer process), and subsequently the toner image transferred on the sheet is fixed to the sheet by fixing treatment such as contact heating type fixing treatment (fixing process). Thus, a visible image can be obtained.

### Example

### Fabrication of Coating Material 1

To an aqueous solution of sodium benzene sulfonate of 0.3% by mass, methacrylic acid cyclohexyl and methacrylic acid methyl were added at a “mass ratio=50:50” (copolymerization ratio) and potassium persulfate in an amount corresponding to 0.5% by mass with respect to the total amount of a monomer was added to carry out emulsion polymerization. A resultant product was dried with a spray drier, thereby fabricating a “coating material 1”. A weight average molecular weight of the obtained coating material 1 was 500,000.

(Fabrication of Coating Materials 2 to 5)

“Coating materials 2 to 5” were obtained in the same manner as in the fabrication of the coating material 1 except that the ratio of methacrylic acid cyclohexyl and methacrylic acid methyl was changed according to Table 1.

(Fabrication of Coating Material 6)

A “coating material 6” was obtained in the same manner as in the fabrication of the coating material 1 except that the addition amount of potassium persulfate was changed to 0.3% by mass with respect to the total amount of a monomer.

(Fabrication of Coating Material 7)

A “coating material 7” was obtained in the same manner as in the fabrication of the coating material 1 except that the addition amount of potassium persulfate was changed to 0.8% by mass with respect to the total amount of a monomer.

(Fabrication of Coating Material 8)

A “coating material 8” was obtained in the same manner as in the fabrication of the coating material 1 except that potassium persulfate was changed to t-butyl hydroperoxide.

(Fabrication of Coating Material 9)

A “coating material 9” was obtained in the same manner as in the fabrication of the coating material 1 except that methacrylic acid cyclohexyl was changed to methacrylic acid cyclopentyl.

(Fabrication of Coating Material 10)

A “coating material 10” was obtained in the same manner as in the fabrication of the coating material 1 except that methacrylic acid cyclohexyl was changed to methacrylic acid cyclooctyl.

(Fabrication of Coating Material 11)

A “coating material 11” was obtained in the same manner as in the fabrication of the coating material 1 except that methacrylic acid cyclohexyl was changed to acrylic acid cyclohexyl.

(Fabrication of Coating Material 12)

A “coating material 12” was obtained in the same manner as in the fabrication of the coating material 6 except that after emulsion polymerization, a resultant product was washed three times with 10 fold amount of ion exchanged water and subsequently dried with a spray drier.

(Fabrication of Coating Material 13)

A “coating material 13” was obtained in the same manner as in the fabrication of the coating material 7 except that after emulsion polymerization, 0.5% by mass of sodium benzene sulfonate was further added.

(Fabrication of Coating Material 14)

A “coating material 14” was obtained in the same manner as in the fabrication of the coating material 1 except that methacrylic acid cyclohexyl was changed to p-t-butyl styrene.

<Manufacture of Carrier 1>

A Mn—Mg-based “ferrite particle” having a volume average diameter of 60 μm and saturation magnetization of 63 A·m²/kg was prepared.

100 parts by mass of the “ferrite particle” prepared as above, as a core material particle, and 3.5 parts by mass of the “coating material 1” were put into a high-speed stirring mixer equipped with a horizontal stirring blade and mixed while stirring under the condition of a circumferential speed of the horizontal rotation blade of 8 m/sec at 22° C. for 15 minutes, and subsequently mixed at 120° C. for 50 minutes. Thus, the surface of the core material particle was coated with the coating material by the action of mechanical impact force (mechanochemical method), thereby manufacturing a “carrier 1”.

<Manufacture of Carriers 2 to 14>

“Carriers 2 to 14” were manufactured in the same manner as in the manufacture of the carrier 1 except that the coating material 1 was changed to the coating materials 2 to 14, respectively.

TABLE 1

| | | | | | | Weight |
|---|---|---|---|---|---|---|
| | Coating | | | | | Average |
| Carrier | Material | | | Copolymerization | | Molecular |
| No. | No. | Monomer 1 | Monomer 2 | Ratio | S/C | Weight |
| Carrier 1 | Coating | Methacrylic | Methacrylic | 50/50 | 0.0045 | 500,000 |
| | Material 1 | Acid | Acid Methyl | | | |
| | | Cyclohexyl | | | | |
| Carrier 2 | Coating | Methacrylic | — | 100/0 | 0.0045 | 500,000 |
| | Material 2 | Acid | | | | |
| | | Cyclohexyl | | | | |
| Carrier 3 | Coating | Methacrylic | Methacrylic | 80/20 | 0.0045 | 500,000 |
| | Material 3 | Acid | Acid Methyl | | | |
| | | Cyclohexyl | | | | |
| Carrier 4 | Coating | Methacrylic | Methacrylic | 20/80 | 0.0045 | 500,000 |
| | Material 4 | Acid | Acid Methyl | | | |
| | | Cyclohexyl | | | | |
| Carrier 5 | Coating | Methacrylic | Methacrylic | 10/90 | 0.0045 | 500,000 |
| | Material 5 | Acid | Acid Methyl | | | |
| | | Cyclohexyl | | | | |
| Carrier 6 | Coating | Methacrylic | Methacrylic | 50/50 | 0.003 | 1,000,000 |
| | Material 6 | Acid | Acid Methyl | | | |
| | | Cyclohexyl | | | | |
| Carrier 7 | Coating | Methacrylic | Methacrylic | 50/50 | 0.008 | 300,000 |
| | Material 7 | Acid | Acid Methyl | | | |
| | | Cyclohexyl | | | | |
| Carrier 8 | Coating | Methacrylic | Methacrylic | 50/50 | 0.0045 | 400,000 |
| | Material 8 | Acid | Acid Methyl | | | |
| | | Cyclohexyl | | | | |
| Carrier 9 | Coating | Methacrylic | Methacrylic | 50/50 | 0.0045 | 450,000 |
| | Material 9 | Acid | Acid Methyl | | | |
| | | Cyclopentyl | | | | |
| Carrier | Coating | Methacrylic | Methacrylic | 50/50 | 0.0045 | 400,000 |
| 10 | Material | Acid | Acid Methyl | | | |
| | 10 | Cyclooctyl | | | | |
| Carrier | Coating | Methacrylic | Methacrylic | 50/50 | 0.005 | 450,000 |
| 11 | Material | Acid | Acid Methyl | | | |
| | 11 | Cyclohexyl | | | | |
| Carrier | Coating | Methacrylic | Methacrylic | 50/50 | 0.002 | 1,000,000 |
| 12 | Material | Acid | Acid Methyl | | | |
| | 12 | Cyclohexyl | | | | |
| Carrier | Coating | Methacrylic | Methacrylic | 50/50 | 0.009 | 300,000 |
| 13 | Material | Acid | Acid Methyl | | | |
| | 13 | Cyclohexyl | | | | |
| Carrier | Coating | p-t-Butyl | Methacrylic | 50/50 | 0.0045 | 400,000 |
| 14 | Material | Styrene | Acid Methyl | | | |
| | 14 | | | | | |

<Manufacture of Toner 1>

(Fabrication of Fine Core Resin Particle)

(1) Preparation of Fine Resin Particle [1H] Dispersion

In a reactor equipped with a stirring device, a temperature sensor, a cooling tube, and a nitrogen introduction device, 7.08 parts by mass of sodium dodecyl sulfonate as an anionic surfactant was dissolved in 3010 parts by mass of ion exchanged water to fabricate a surfactant solution. Then, while stirring this surfactant solution at a stirring rate of 230 rpm under a flow of nitrogen, the temperature within the reactor was raised to 80° C.

Then, a polymerization initiator solution composed of 9.2 parts by mass of potassium persulfate (KPS) as a polymerization initiator dissolved in 200 parts by mass of ion exchanged water was put into the surfactant solution, and the temperature within the reactor was brought to 75° C. Subsequently, a mixed solution [a1] formed by mixing 69.4 parts by mass of styrene, 28.3 parts by mass of acrylic acid-n-butyl, and 2.3 parts by mass of methacrylic acid was dropwisely added for 1 hour and further stirred at 75° C. for 2 hours to carry out polymerization. Thereby, a fine resin particle [1H] dispersion including a fine resin particle [1H] dispersed therein was prepared.

(2) Preparation of Fine Resin Particle [1HM] Dispersion

97.1 parts by mass of styrene, 39.7 parts by mass of acrylic acid-n-butyl, 3.22 parts by mass of methacrylic acid, and 5.6 parts by mass of n-octyl-3-mercaptopropionic acid ester were put into a flask equipped with a stirring device and 98.0 parts by mass of pentaerythritol tetrabehenate was further added thereto, and heated at 90° C. Thereby, a mixed solution [a2] formed by mixing the above compounds was prepared.

On the other hand, in a reactor equipped with a stirring device, a temperature sensor, a cooling tube, and a nitrogen introduction device, a surfactant solution having 1.6 parts by mass of sodium dodecyl sulfonate dissolved in 2700 parts by mass of ion exchanged water was fabricated and heated at 98° C. The fine resin particle [1H] dispersion was added in an amount of 28 parts by mass in terms of solid content to the surfactant solution, and subsequently the mixed solution [a2] was put thereto. Further, the mixture was mixed and dispersed for 2 hours using a mechanical dispersion device having a circulation path, “CLEARMIX” (manufactured by M Technique Co., Ltd.) to prepare a dispersion (emulsion).

Then, an initiator solution composed of 5.1 parts by mass of potassium persulfate (KPS) dissolved in 240 parts by mass of ion exchanged water and 750 parts by mass of ion exchanged water were added to the emulsion, and this reaction system was stirred at 98° C. for 2 hours to carry out polymerization. Thereby, a fine resin particle [1HM] dispersion in which a fine resin particle [1HM] having a complex structure including a surface of the fine resin particle [1H] coated with a resin was dispersed was prepared.

(3) Preparation of Fine Resin Particle [1HML] Dispersion

An initiator solution having 7.4 parts by mass of potassium peroxide (KPS) dissolved in 200 parts by mass of ion exchanged water was added to the above-described fine resin particle [1HM] dispersion, and a temperature thereof was adjusted to 80° C. Subsequently, a mixed solution [a3] formed by mixing 277 parts by mass of styrene, 113 parts by mass of acrylic acid-n-butyl, 9.21 parts by mass of methacrylic acid, and 10.4 parts by mass of n-octyl-3-mercaptopropionic acid ester was dropwisely added for 1 hour. After the dropwise addition, the mixture was heated and stirred for 2 hours while maintained at 80° C. to carry out polymerization. Subsequently, the reaction system was cooled to 28° C. Thereby, a fine resin particle [1HML] dispersion in which a fine resin particle [1HML] having a complex structure including a surface of the resin particle 1HM coated with a resin was dispersed was prepared. The fine resin particle [1HML] dispersion thus obtained is referred to as a “fine core resin particle dispersion”.

(Preparation of Fine Shell Resin Particle [1] Dispersion)

In a reactor including a stirring device, a temperature sensor, a cooling tube, and a nitrogen introduction device, 2.0 parts by mass of sodium dodecyl sulfonate as an anionic surfactant was dissolved in 3000 parts by mass of ion exchanged water to fabricate a surfactant solution. While stirring this surfactant solution at a stirring rate of 230 rpm under a flow of nitrogen, the internal temperature was raised to 80° C.

On the other hand, a mixed solution [a4] was prepared by adding and mixing 544 parts by mass of styrene, 160 parts by mass of acrylic acid-n-butyl, 96 parts by mass of methacrylic acid, and 20 parts by mass of n-octyl mercaptan (NOM).

After an initiator solution formed by dissolving 10 parts by mass of potassium persulfate (KPS) in 200 parts by mass of ion exchanged water was added to the surfactant solution, the above-described mixed solution [a4] was dropwisely added for 3 hours. Then, this system was brought to 80° C. and heated and stirred for 1 hour to carry out polymerization. Thereby, a “fine shell resin particle dispersion” was prepared.

(Preparation of Carbon Black Dispersion [1])

While a solution fabricated by stirring and dissolving 90 parts by mass of sodium dodecyl sulfonate in 1600 parts by mass of ion exchanged water was stirred, 420 parts by mass of carbon black “Mogul L” was slowly added to this solution. Then, dispersion treatment was carried out using a stirring device “CLEARMIX” (manufactured by M Technique Co., Ltd.) to prepare a “carbon black dispersion[1]”. A particle diameter of the carbon black in the carbon black dispersion [1] was measured using an electrophoretic light-scattering photometer “ELS-800” (manufactured by Otsuka Electronics Co., Ltd.), and a mass average particle diameter was found to be 110 nm.

(Formation of Core Particle)

450 parts by mass (in terms of the solid content) of the fine core resin particle dispersion, 1100 parts by mass of ion exchanged water, and 100 parts by mass (in terms of the solid content) of the carbon black dispersion[1] were put into a reactor including a stirring device, a temperature sensor, a cooling tube, and a nitrogen introduction device, and the temperature of the solution was adjusted to 30° C. Subsequently, 5 mol/liter of an aqueous sodium hydroxide solution was added to adjust a pH to 10.0.

While the above-described reaction system was stirred, in the state an aqueous solution formed by dissolving 60 parts by mas of magnesium chloride hexahydrate in 60 parts by mass of ion exchanged water was added to the above-described reaction system for 10 minutes. After the addition, the reaction system was left as was for 3 minutes, and subsequently the temperature rising was started. Then, the temperature of this system was raised to 90° C. for 60 minutes, and resin particles were associated while the temperature was held at 90° C. to grow the particles. The growth of the particles was confirmed by measuring a particle diameter of the associated particles with use of “Multisizer 3” (manufactured by Beckman Coulter Inc.). Then, when a median diameter (D₅₀) based on volume reached 5.5 μm, an aqueous solution having 40.2 parts by mass of sodium chloride dissolved in 1000 parts by mass of ion exchanged water was added to the reaction system to stop the growth of the particles and form a “core particle”.

(Formation of Shell)

Next, 550 parts by mass (in terms of the solid content) of a dispersion of the above-described core particle was brought to 90° C., and 50 parts by mass (in terms of the solid content) of the fine shell resin particle dispersion was added thereto. With continuous stirring for 1 hour, the “fine shell resin particle” was fused to the surface of the “core particle”. Subsequently, an aqueous solution formed by dissolving 40.2 parts by mass of sodium chloride in 1000 parts by mass of ion exchanged water was added thereto. This system was brought to 95° C. and heated and stirred for 20 minutes and then aged to form a shell. Subsequently, the shell was cooled to 30° C.

The produced toner particle dispersion was filtered and washed three times with 10 fold amount of ion exchanged water at 35° C., and subsequently dried with warm air at 40° C., thereby fabricating a “toner particle 1” having a structure in which the surface of the core particle was coated with the shell. In this toner particle 1, a ratio (S/C) of a sulfur element content (S) and a carbon element content (C) was 0.004.

(Addition of External Additive)

1.0% by mass of hydrophobic silica (number average primary particle diameter of 12 nm, hydrophobicity degree of 68) and 1.5% by mass of hydrophobic titanium oxide (number average primary particle diameter of 20 nm, hydrophobicity degree of 64) were added to the toner particle 1 fabricated as described above. After mixing with use of “Henschel mixer” (manufactured by Nippon Coke & Engineering Co., Ltd.), a coarse particle was removed with use of a sieve having a mesh size of 45 μm to manufacture a “toner 1”.

### Fabrication of Two-Component Developer 1

### Example 1

By compounding 95 parts by mass of the “carrier 1” and 5 parts by mass of the “toner 1”, a “two-component developer 1” was fabricated. The two-component developer was fabricated under the environment of normal temperature and normal humidity (a temperature of 20° C., a relative humidity of 50% RH) by mixing the toner and the carrier with use of a V-blender. The treatment was carried out at the number of revolution of the V-blender of 20 rpm for the stirring time of 20 minutes. The mixture was further sieved through a sieve having a mesh size of 125 μm to fabricate the two-component developer.

### Fabrication of Two-component Developers 2 to 14

### Examples 2 to 11 and Comparative Examples 1 to 3

“Two-component developers 2 to 14” were obtained in the same manner as in the fabrication of the two-component developer 1 except that the carrier 1 was changed to the carriers 2 to 14, respectively. Note that the two-component developers 12 to 14 are for comparison.

<<Evaluation>>

As an evaluation equipment for the two-component developers, a commercial high-speed monochrome-on-demand printing system “bizhub PRO 1250” (manufactured by Konica Minolta Inc.) was prepared and loaded with the two-component developers fabricated as described above in sequence to conduct evaluation as follows.

(Evaluation of Fogging)

Fogging was evaluated under the environment of high temperature and high humidity (30° C. 0.80% RH) by printing out blank papers at the beginning and after printing a character image of a printing rate of 5% on 500,000 sheets, and evaluating the blank paper densities of a transfer material at the beginning and after printing on 500,000 sheets. Densities at twenty locations were measured in an A4-size transfer material, and the average value thereof was assumed as a blank paper density. The density was measured using a reflection densitometer “RD-918” (manufactured Macbeth). When a blank paper density is 0.01 or less, the two-component developer is considered to be accepted.

(Evaluation of Scattering of Toner in Device)

As for scattering of the toner in the device, a status of scattering of the toner in the device was visually observed after printing out 500,000 sheets of blank paper under the environment of high temperature and high humidity (30° C. 0.80% RH) and evaluation was conducted according to the following evaluation criteria. When the evaluation is ⊙ and ◯), the two-component developer is considered to be accepted.

—Evaluation Criteria—

⊙: A state where the inside of the device is not stained with the toner.

◯: A state where scattering of the toner into the device is slightly observed.

x: A state where scattering of the toner is significantly observed and the inside of the device needs maintenance.

(Evaluation of Maximum Density)

A maximum density was evaluated under the environment of low temperature and low humidity (10° C.·10% RH) at the beginning and after printing a character image of a printing rate of 5% on 500,000 sheets by printing a black solid image on an A4-size transfer material, and measuring a relative reflection density with reference to a blank paper density in the same way as the fogging density using a reflection densitometer “RD-918” (manufactured by Macbeth). When a density of each black solid image portion is 1.5 or more, the two-component developer is considered to be accepted.

TABLE 2

| | | | | | | | Maximum | |
|---|---|---|---|---|---|---|---|---|
| | | | | Fogging | | | Density | |
| | | | | | After | | | After |
| | Two-component | Carrier | Toner | At the | 500,000 | Toner | At the | 500,000 |
| | Developer No. | No. | No. | beginning | sheets | Scattering | beginning | sheets |
| Example 1 | Two-component | Carrier 1 | Toner 1 | 0.001 | 0.002 | ⊙ | 1.57 | 1.58 |
| | Developer 1 | | | | | | | |
| Example 2 | Two-component | Carrier 2 | Toner 1 | 0.002 | 0.004 | ⊙ | 1.52 | 1.52 |
| | Developer 2 | | | | | | | |
| Example 3 | Two-component | Carrier 3 | Toner 1 | 0.001 | 0.002 | ⊙ | 1.57 | 1.57 |
| | Developer 3 | | | | | | | |
| Example 4 | Two-component | Carrier 4 | Toner 1 | 0.003 | 0.004 | ⊙ | 1.56 | 1.57 |
| | Developer 4 | | | | | | | |
| Example 5 | Two-component | Carrier 5 | Toner 1 | 0.004 | 0.008 | ◯ | 1.55 | 1.56 |
| | Developer 5 | | | | | | | |
| Example 6 | Two-component | Carrier 6 | Toner 1 | 0.001 | 0.002 | ⊙ | 1.57 | 1.56 |
| | Developer 6 | | | | | | | |
| Example 7 | Two-component | Carrier 7 | Toner 1 | 0.002 | 0.004 | ⊙ | 1.59 | 1.60 |
| | Developer 7 | | | | | | | |
| Example 8 | Two-component | Carrier 8 | Toner 1 | 0.003 | 0.008 | ◯ | 1.56 | 1.56 |
| | Developer 8 | | | | | | | |
| Example 9 | Two-component | Carrier 9 | Toner 1 | 0.002 | 0.003 | ⊙ | 1.56 | 1.57 |
| | Developer 9 | | | | | | | |
| Example 10 | Two-component | Carrier | Toner 1 | 0.002 | 0.003 | ⊙ | 1.56 | 1.57 |
| | Developer 10 | 10 | | | | | | |
| Example 11 | Two-component | Carrier | Toner 1 | 0.002 | 0.003 | ⊙ | 1.57 | 1.52 |
| | Developer 11 | 11 | | | | | | |
| Comparative | Two-component | Carrier | Toner 1 | 0.002 | 0.003 | ◯ | 1.45 | 1.49 |
| Example 1 | Developer 12 | 12 | | | | | | |
| Comparative | Two-component | Carrier | Toner 1 | 0.011 | 0.016 | X | 1.55 | 1.57 |
| Example 2 | Developer 13 | 13 | | | | | | |
| Comparative | Two-component | Carrier | Toner 1 | 0.004 | 0.007 | X | 1.42 | 1.44 |
| Example 3 | Developer 14 | 14 | | | | | | |

What is claimed is:

1. An electrostatic charge image developing carrier comprising:
a carrier particle formed by coating a surface of a core material particle with a coating material comprising a resin,
the resin being obtained by polymerizing a monomer including at least an alicyclic methacrylic acid or an alicyclic acrylic acid ester compound, and
the coating material comprising a sulfur element and a ratio (S/C) of the sulfur element content (S) to a carbon element content (C) in the coating material being 0.003 to 0.008.

2. An electrostatic charge image developing carrier according to claim 1,
wherein the alicyclic methacrylic acid or the alicyclic acrylic acid ester compound has a cycloalkyl group having 5 to 8 carbon atoms.

3. An electrostatic charge image developing carrier according to claim 1,
wherein the alicyclic methacrylic acid or the alicyclic acrylic acid ester compound is methacrylic acid or acrylic acid cyclohexyl.

4. An electrostatic charge image developing carrier according to claim 1,
wherein the monomer for obtaining the resin consists of an alicyclic methacrylic acid or an alicyclic acrylic ester compound and a chain methacrylic acid or a chain acrylic acid ester compound.

5. An electrostatic charge image developing carrier according to claim 1,
wherein a rate of the alicyclic methacrylic acid or the acrylic acid ester compound in the monomer for obtaining the resin is 20 to 80% by mass.

6. An electrostatic charge image developing carrier according to claim 1,
wherein the coating material comprises the sulfur element as a sulfonic acid group or a sulfonate group.

7. An electrostatic charge image developing carrier according to claim 1,
wherein the resin comprises the sulfur element as a sulfonic acid group or a sulfonate group.

8. An electrostatic charge image developing carrier according to claim 1,
wherein the ratio (S/C) of the sulfur element content (S) to the carbon element content (C) in the coating material being 0.0035 to 0.007.

9. An electrostatic charge image developing carrier according to claim 4,
wherein the chain methacrylic acid or the chain acrylic acid ester compound is methyl methacrylate.

10. A two-component developer comprising:
an electrostatic charge image developing toner formed of a toner particle; and
an electrostatic charge image developing carrier formed of a carrier particle;
wherein the electrostatic charge image developing carrier is an electrostatic charge image developing carrier according to claim 1, and
the toner particle being a constituent the electrostatic charge image developing toner comprises a sulfur element.
